(19) United States
(12) Patent Application Publication
(10) Pub. No.: US 2018/0276881 A1
(43) Pub. Date: Sep. 27, 2018

(54) NON-UNIFORM RESOLUTION MAP TILING IN A GEOSPATIAL MAPPING SYSTEM

(71) Applicant: EarthX, Inc., San Francisco, CA (US)

(72) Inventors: Kyle VanderLugt, San Bruno, CA (US); Thomas Gaskins, Seattle, WA (US); Dean Addison, British Columbia (CA); Jeffery Addison, British Columbia (CA)

(21) Appl. No.: 15/679,065

(22) Filed: Aug. 16, 2017

Related U.S. Application Data
(63) Continuation-in-part of application No. 15/465,474, filed on Mar. 21, 2017.

(51) Int. Cl. G06T 17/05; G06T 15/00; G06F 3/0346; G06F 3/0481

(52) U.S. Cl. CPC G06T 17/05; G06T 15/005; G06T 2210/36; G06F 3/04815; G06F 3/0346

(57) ABSTRACT

A method of geospatial mapping geospatial mapping of a map layer includes generating ‘N’ number of map tiles, ‘N’ being an integer value, where each of the map tiles is associated with a unique resolution and acuity. A group of map tiles defines a non-linear map layer and a group of non-linear map layers defines a map layer catalogue. Location (L) and region (R) information, defining a current location of the client device, are received from a client device. The combination of location L and region R defines an area of display presented to a user by the client device. Further, upon activation by the user, a portion of stored map tiles, of one or more groups of map tiles, is deployed to the client device to be assembled and displayed as a map layer in an area of the client device defined by L and R.

### CROSS REFERENCE TO RELATED APPLICATIONS

This application is a continuation-in-part of U.S. application Ser. No. 15/465,474, filed on Mar. 21, 2017, entitled “SYSTEM AND METHOD FOR RENDERING GEOSPATIAL MAPS”, by Kyle Vanderlugt, et al.

### BACKGROUND

Geospatial mapping is employed in displaying a digital representation, in various forms, of the globe, space, and beyond. Attributes of such displays, such as the earth's terrain, temperature and other associated characteristics, are commonly mapped on a computer or a smartphone, for instance. In the last couple of decades, particularly with the advent of the Internet, software has found numerous applications, beyond that which was even contemplated in years prior. Accordingly, with the state of the technology, for example, earth can be viewed, on various devices, from space, it can be viewed in detail at selected areas upon the user zooming in and vice versa. These are among a host of other display manipulations for mapping the globe, space, and beyond.

Multiple approaches have led to the geospatial (digital) representation of geographic areas including terrestrial sites. One such approach includes selection of a map layer by a user of a client device, such as a computer, a smartphone or other computational devices having a display for viewing, as described above. Selection of a map layer is typically based on the specific content interest to the user. Upon the selection of a map layer, “tiles” (also referred to as “map tiles”) of the selected map layer are requested of a computational device based on specified geospatial boundaries. “Tiles” are readily utilized in geospatial mapping and utilized for generating a digital representation of a map to be viewed through the display of a browser, for example.

Upon receipt of a request for tiles, from the client device, a query is made against the map layers and geospatial tiles in the geospatial map server or (cache) memory of the client device. Upon the detection of a match between the information accompanying the request and the geospatial tiles, the requested (map) tiles are retrieved and deployed to the display interface of the client device for viewing.

Geospatial map layers and tiles are generated by processing data. First, data, potentially received from multiple sources including third party storage devices, is downloaded in its raw form and organized into searchable database form and stored accordingly. Map data/file is subsequently stylized by the application of stylistic, visualistic, and spatial filters to the stored data, before the stored data is converted into, and stored as, map layer files.

Lastly, the visualized map layers are split into tiles of congruous shapes and sizes using services, such as web mapping server (WMS) or a Web Mapping Tiling Service (WMTS). This process is applicable and appropriate for rendering both raster and vector tiles.

One of the drawbacks of current map layer deployment, techniques is the vast amount of portrayed data, particularly in three-dimensional map layers, for example, on a globe, make the visualization of points or areas-of-interest difficult to discern relative to areas that are not of interest to the user, i.e. areas-of-non-interest. Currently, there is no adequate process or system to address the foregoing, in addition to perhaps other, limitations of mapping systems.

### SUMMARY OF VARIOUS EMBODIMENTS

Briefly, a method of geospatial mapping geospatial mapping of a map layer includes generating ‘N’ number of map tiles, ‘N’ being an integer value, where each of the map tiles is associated with a unique resolution and acuity. A group of map tiles defines a non-linear map layer and a group of non-linear map layers defines a map layer catalogue. Location (L) and region (R) information, defining a current location of the client device, are received from a client device. The combination of location L and region R defines an area of display presented to a user by the client device. Further, upon activation by the user, a portion of stored map tiles, of one or more groups of map tiles, is deployed to the client device to be assembled and displayed as a map layer in an area of the client device defined by L and R.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a geospatial mapping system 10, in accordance with some implementations of the invention.

FIG. 2 shows an exemplary geospatial mapping system 30, in accordance with some implementations of the invention.

FIG. 3 shows a geospatial mapping system 70, in accordance with some embodiments of the invention.

FIG. 4 shows another exemplary geospatial mapping system 40 including a number of third party servers 46 and associated database 44, in accordance with some embodiments of the invention.

FIG. 5 shows an exemplary geospatial map system 50 with multiple map layers stored in one or more databases, in accordance with some implementations of the invention.

FIG. 6 shows, in conceptual block diagram form, a geospatial mapping system 1100, in accordance with some implementations of the invention.

FIG. 7 shows, in conceptual block diagram form, a geospatial mapping system 500 with further details of the server 506, in accordance with some embodiment of the invention.

FIGS. 8a and 8b show, in conceptual block diagram form, a geospatial mapping system 600, in accordance with various implementations of the invention.

FIG. 9 shows exemplary implementations of maps showing 3-D navigation using differential map tiling process of the various implementations of the invention.

FIG. 10 shows a map of a user navigating from one location, shown in one map, to a new location, shown by the other map.

FIG. 11 shows various locations of a user relative to earth where map tiling is starts at a different location relative to earth, consistent with the location of the user, in accordance with some implementations of the invention.

FIG. 12 shows a flow diagram of some of the steps performed to generate map tiles, in accordance with exemplary methods of the invention.

FIG. 13 shows a flow diagram of some of the interactions between the client device and the geospatial map server, in accordance with various methods of the invention.

FIG. 14 shows various map tiles 1300, in accordance with some of the implementations of the invention.

FIGS. 15-16 show screen shots of an exemplary implementation of the invention where a map catalogue including various map layers is presented to the user at the client device interface/display and the resulting effect of the user's selection of one of the map layers.

### DETAILED DESCRIPTION OF THE EMBODIMENTS

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of various implementations of the invention. It should be noted that the figures discussed herein are not drawn to scale and thicknesses of lines are not indicative of actual sizes.

In accordance with a method and apparatus of the invention, a geospatial mapping system generates map layers, comprised of geospatial map tiles that are deployed to the client device and displayed to a user of the client device. One of the methods of map tiling in the geospatial mapping system includes generating N number of map tiles, ‘N’ being an integer value. Each of the N number map tiles is associated with a unique resolution and acuity. The unique resolution and acuity are based on the spatial resolution of the data. The person(s)/user generating the map determines how to best break up the map into distinct map tiles during map layer creation process. In general, the higher the resolution of the data, the greater the number of map tiles that can be created and the higher the resolution of the map layer.

The method further includes storing the generated N number of map tiles in a database of a geospatial map server that is for housing the map tiles. The server is in communication with the client device through a communication network.

Location (L), the location identified as the location of the client device and region (R), the region, a region around L, define a current location of the user client device, and received, by the server, from the client device. The combination of the L and the R define an area of display of the client device. A selected number of the stored map tiles is retrieved from the database for transmission to, and displaying by, the client device. The selected number is based on the size of the area of display of the user client device. Upon activation of a different map layer, stored map tiles corresponding to the different map layer are retrieved from the database for transmission to, and displaying by, the client device as a map layer. In various implementations, the foregoing two map layers may co-exist in the client device interface.

Accordingly, in an exemplary implementation, N number of map tiles result in a non-linear map layer, “N” being an integer value. That is, each of the map tiles is associated with a unique resolution and acuity and a group of map tiles defines a map layer and a group of map layers defines a map layer catalogue. Map tiles of a common group carry/store a distinct amount of information/data relative to map tiles of other groups. For instance, map tiles of the group of map tiles located closest to L and R may each carry the most amount of information relative to the map tiles of other groups.

The generated N map tiles are stored in a server database before deployment to a client device. Upon activation by the user, a portion of the stored map tiles, of one or more groups, is deployed to the client device and assembled as a map layer in an area of the client device display defined by L and R. In various implementations of the invention, tiling of the map layer around L and within R create a non-linear map layer.

In an exemplary implementation, tiling of a map layer around L and within R results in the creation a non-linear map layer. In a non-linear map layer where multiple tiles are used to generate a map layer, each tile is internally uniform in terms of the data/information stored or used throughout the tile. Tiles contain sequentially less information on a per-tile basis, the farther the tile is from L. Tile information may decrease linearly, logarithmically, or decrease in some other non-linear fashion. Tiles may be logarithmic, spherical, dome shape, and any other suitable formation. Further, tiles may be compressed.

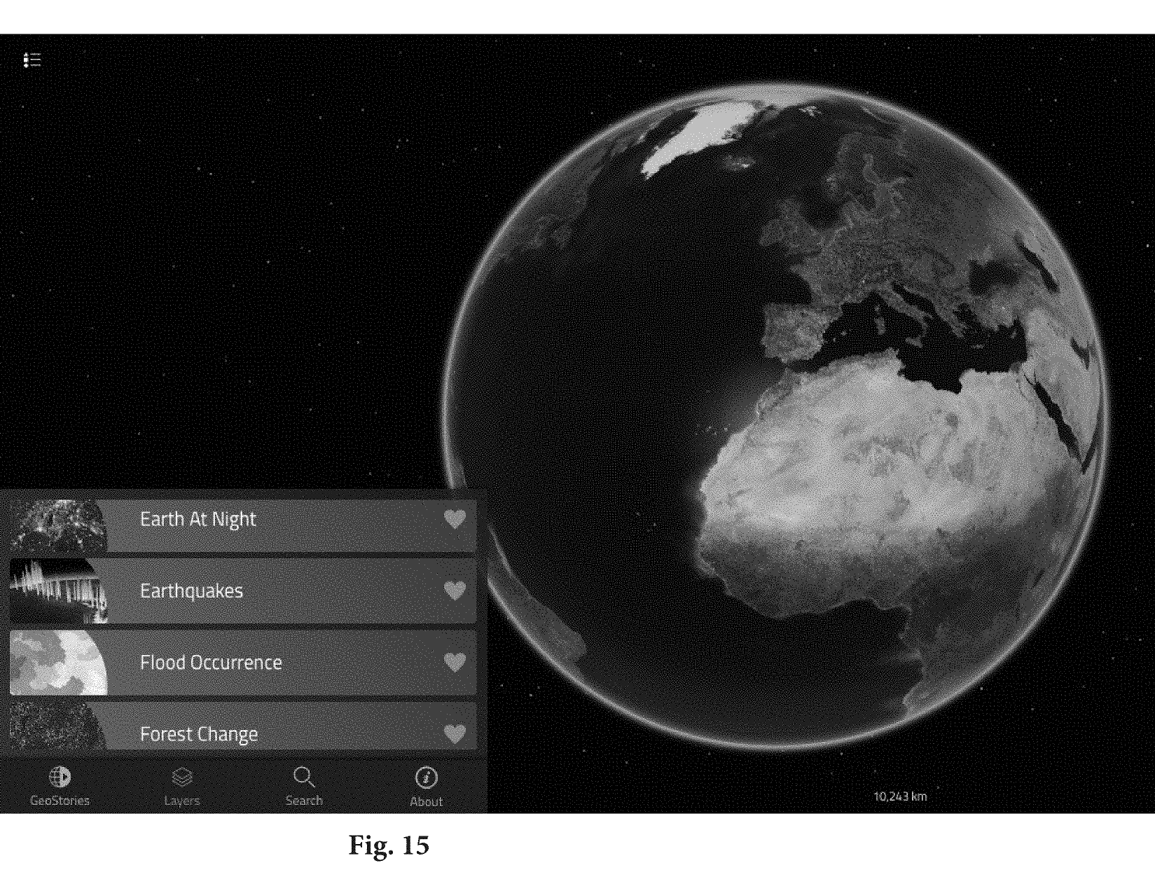

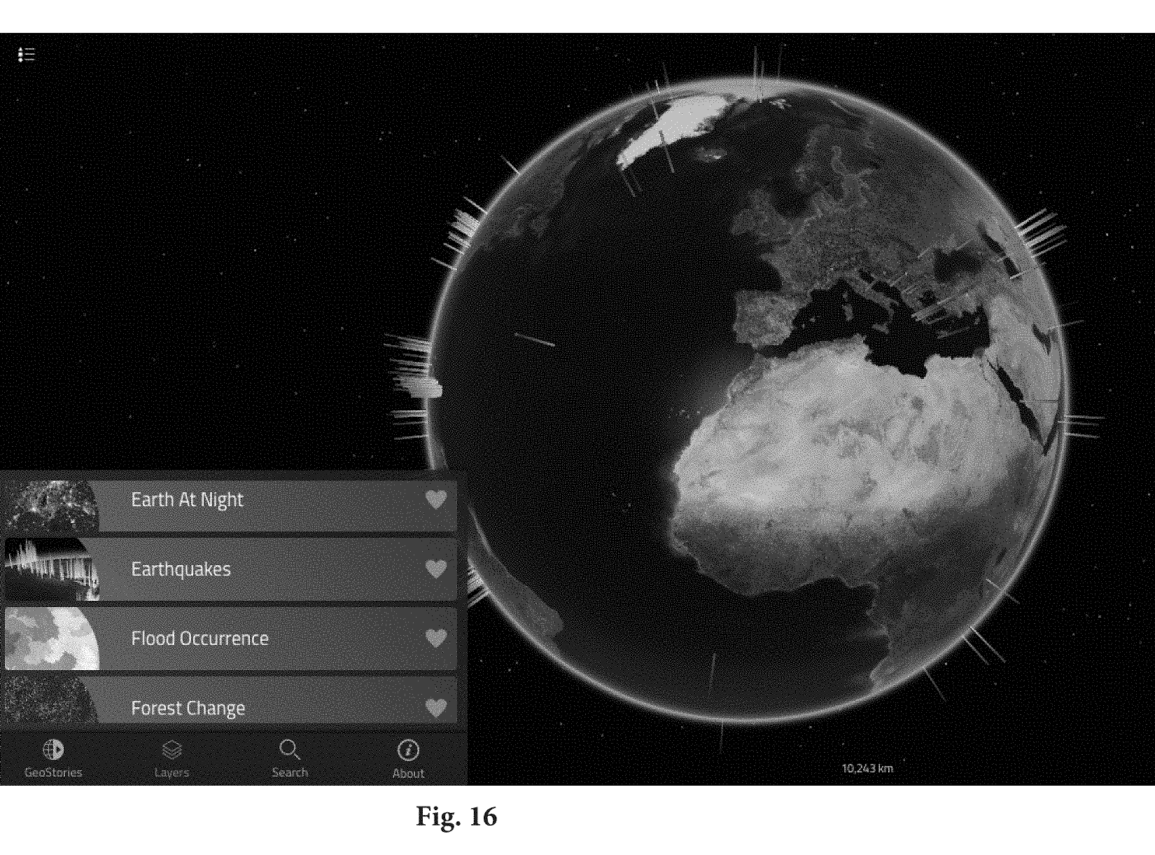

In accordance with a method of the invention, an exemplary system allows the user to activate a map layer from the map layer catalogue. Activation of the map layer triggers the deployment and assembly of map tiles for the selected map layer, to the client, as shown and described relative to FIGS. 15-16. A change in the client device interface results from zooming, panning, or changing the area of interest (or “area of display”) in the client device display. Accordingly, the user's action of zooming, panning, or changing the area of interest triggers a change in the area of display (or area-of-interest) and map tiles are updated, assembled, and deployed accordingly.

In an embodiment of the invention, a differential or non-linear map tiling process is employed. These are merely a couple of examples of the various map tiling process that may be employed. In summary, a non-linear map tiling process is employed.

Geospatial tiles are assembled into map layers in the client interface around a selected geographic area defined by the boundaries of the client device interface. The device, also referred to herein as “client device” may be, without any limitation, a handheld device, such as a smartphone.

In accordance with a method and apparatus of the invention, a request is made by the client device to a geospatial map server. The geospatial map server may be made of one or more than one physical servers, which may be located in the same location or different locations.

The request is for map tiles of suggested map layers, which are ultimately generated by the geospatial map server. The client device and the geospatial map server communicate with each other via a communication network, such as but not limited to the Internet.

The request includes the location of the client device that may be obtained through a global positioning system (GPS).

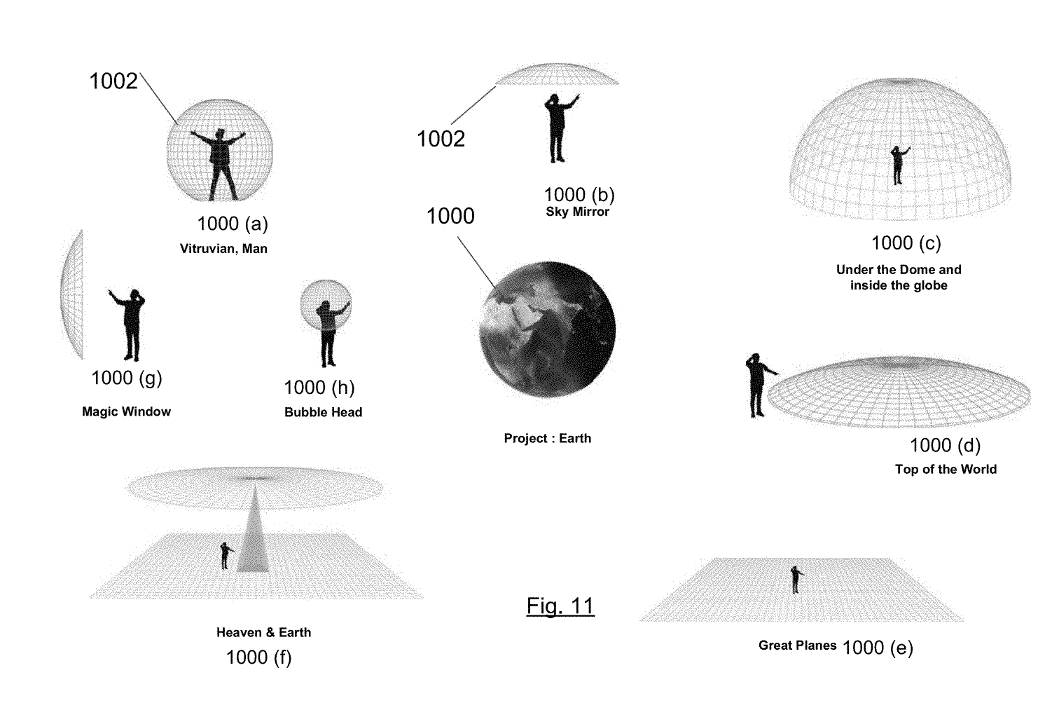

The geospatial map server generates recommended map layers and associated map tiles that may or may not be congruent. More generally, map tiling is performed non-linearly, which can be used to generate various map layers geometry configurations, such as spherical, logarithmic, and other types, as shown in FIG. 11. In an optional technique, map tiles may additionally be compressed.

It is noted that only tiles needed for the area of display (or area-of-interest) on the client device are deployed or sent to the client device. Stated differently, map tiles that are associated with a selected map layer are deployed and assembled in the area of display of the client's device where the map is to be viewed by the user.

In the client device, a map layer catalogue, made of map layers, may be created. A map layer catalogue is made of map layers which are shown to the user on the client device. These map layers are shown on the display of the client device by the client device interface. Such map layers are generally not stored in the client device and are rather transmitted by the geospatial map server, as requested by the client device. In various implementations of the invention, the geospatial map server's database contains all map tiles for all map layers.

A map layer deployment engine of the geospatial map server deploys the (selected) map layers and map tiles, through the communication network, to the client device. The deployed map tiles represent only a portion of generated map tiles which represent the defined geographic boundaries of the region R surrounding the location L of the client device. The region R may be defined by boundaries of the selected area of the display, typically, an area that is of interest to the user.

In accordance with an embodiment and method of the invention, map/data layers may be tiled and processed but only map tiles that are actually required are assembled in the map layer at region R. Tiles that comprise geographic areas not represented or viewed in the current device client interface of the client device are not deployed, in an embodiment of the invention. As the user takes action, for instance changing the area of display by zooming in, only the tiles required for the new areas-of-interest are deployed. New zoomed-in image is tiled and all other images remain un-tiled. This saves processing time and power.

Tiling is performed non-linearly, in accordance with some implementations of the invention, therefore, the tiles that make up an area-of-interest, as shown on the client device display, are not all the same size with the same acuity. Rather, the tiles may be assembled such that the tiles representing an area closer to the location of the client device are displayed with greater acuity, and perhaps smaller, relative to those located farther away from the client device. Tiles that are located further away from the Location L, relative to tiles closer to the Location L contain less acuity, therefore having less data/information to store thereby decreasing processing time and reducing memory/storage capacity requirements. The assembly of tiles in this non-linear fashion may be used to generate multiple map layer geometries including logarithmically or in logarithmic spherical view where the tiles representing an area closer to the location of the client device are displayed with greater acuity, and perhaps even larger in size, relative to those located farther away from the client device. This results in decreased processing time and a lower memory/storage capacity requirement.

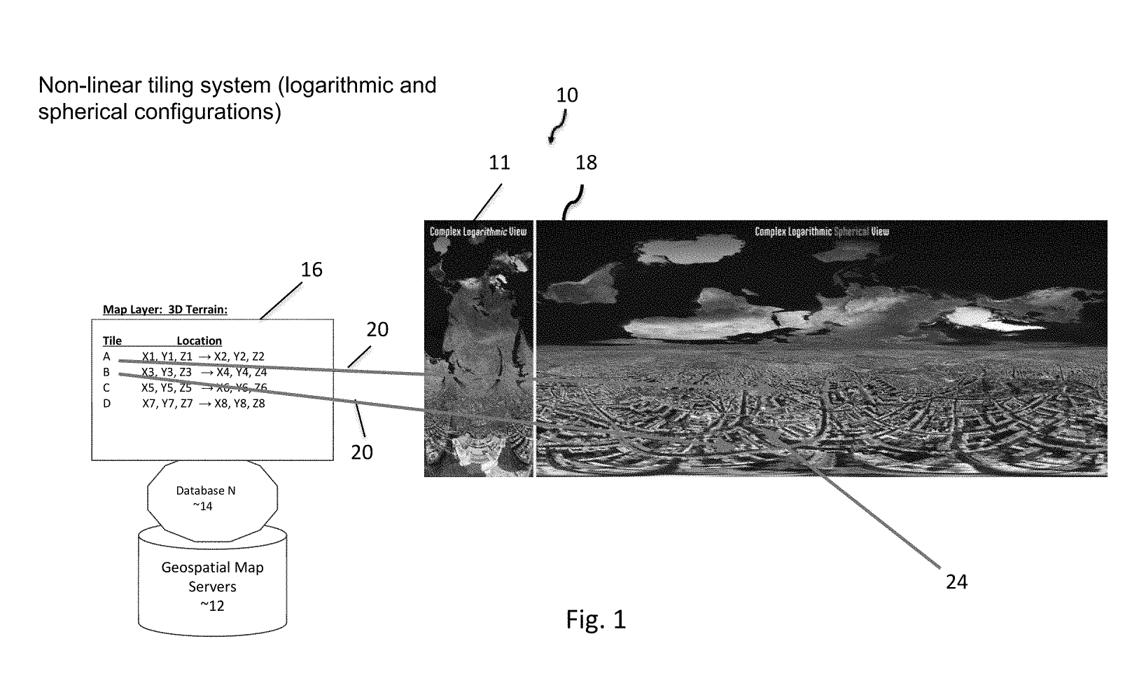

Referring now to FIG. 1, in accordance with some implementations of the invention, a geospatial mapping system 10 of an exemplary map layer of 3-dimensional (3-D) terrain plates is shown with many tiles saved in the database N 14 of the geospatial map server. Only the 3D terrain map layer 16 is visible though many other map layers may be maintained in the database 14. The 3-D terrain map layer is generated by the geospatial map server 12, which may be made of more than one server. The database N 14 may include more than one physical database and may be a part of the server 12 or located externally to the server 12, or a part of another system altogether. The map layer 16 is displayed on a three-dimensional (3D) earth viewed within the display 18, which is a part of the client device interface, as later explained relative to subsequent figures. The geospatial map server 12 is communicatively coupled to database 14. It is understood that FIG. 1 shows merely one example, among many others, of a system in which an embodiment and method of the invention may be employed.

In the system shown in FIG. 1, 3-D terrain are graphically shown in the display 18 of a client device (not shown in FIG. 1) and viewed by a user thereof. The displayed 3-D terrain is made of map tiles that are in turn created from a 3D terrain map layer. The tiles are retrieved from the database 14. Database 14 may contain “N” number of map layers (not shown), “N” being an integer value. Each of the N databases includes one or more map layers and associated map tiles.

Briefly, the geospatial map server 12, responds to the client device with the display 18 and deploys the generated 3-D terrain map tiles to the client device. Appropriate visualized map layer information is shown at 24 of the display 18 and discussed in further detail below.

In accordance with an embodiment and method of the invention, the contents of the database 14, in addition to the map layer 16, may contain a list of meta-data such as various locations-of-interest, associated with the selected areas, identified by a name, such as “A”, “B”, . . . , that correspond to boundaries, such as “X1, Y1, Z1-->X2, Y2, Z2” for the area identified by the name “A”. The arrows 20 points to locations, shown at 24, on the display 18 defined by locations “A”, “B”, “C”, and “D” of the map layer 16.

Map tiling may be performed non-linearly and optionally with the map tiles compressed, in accordance with an embodiment of the invention. Examples of non-linear, without limitation, include logarithmic and spherical geometries. In the exemplary implementation of FIG. 1, map tiles are shown at 11.

In an exemplary implementation, among a host of others, an individual tile may be formed from many individual pixels and many tiles make up a map layer. Tiles may also be comprised of vector data in the form of points, lines, polylines, and polygons, to name some examples. The non-linear process occurs when multiple tiles of varying distinct levels of stored information, either raster or vector, are assembled together. Within an individual tile, information is stored uniformly. However, adding different tiles together, which contain varying amounts of stored information in the form of raster or vector data, creates a non-linear tiling process or a non-linear map layer. The process of assembling the tiles in sequential order of decreasing visual acuity is referred to herein as being “non-linear”. For a map layer in Region R, the tiles that are positioned closer to the Location L (referred to herein as “near field”) have more information, accordingly, they enjoy a higher level of detail and acuity. In contrast thereto, the tiles in the Region R that are positioned further from the Location L (referred to herein as “far field”) have less information in each tile and therefore have a lower level of visual acuity. In summary, as the distance, within the Region R, from the location L of the client device to the location travelled by the client device becomes farther and farther away from the Location L, the amount of stored information in the form of raster or vector data in each tile reduces accordingly.

As seen at 24, tiles may be generated and assembled such that the tiles closer to the location of the client device are displayed with greater acuity, and perhaps even larger, relative to those located farther away from the client device. This results in decreased processing time and a lower memory/storage capacity requirement. Perhaps even more importantly, the user enjoys graphics with greater resolution at the area pointed than distances farther away.

In some implementations of the invention, map tiles are congruent.

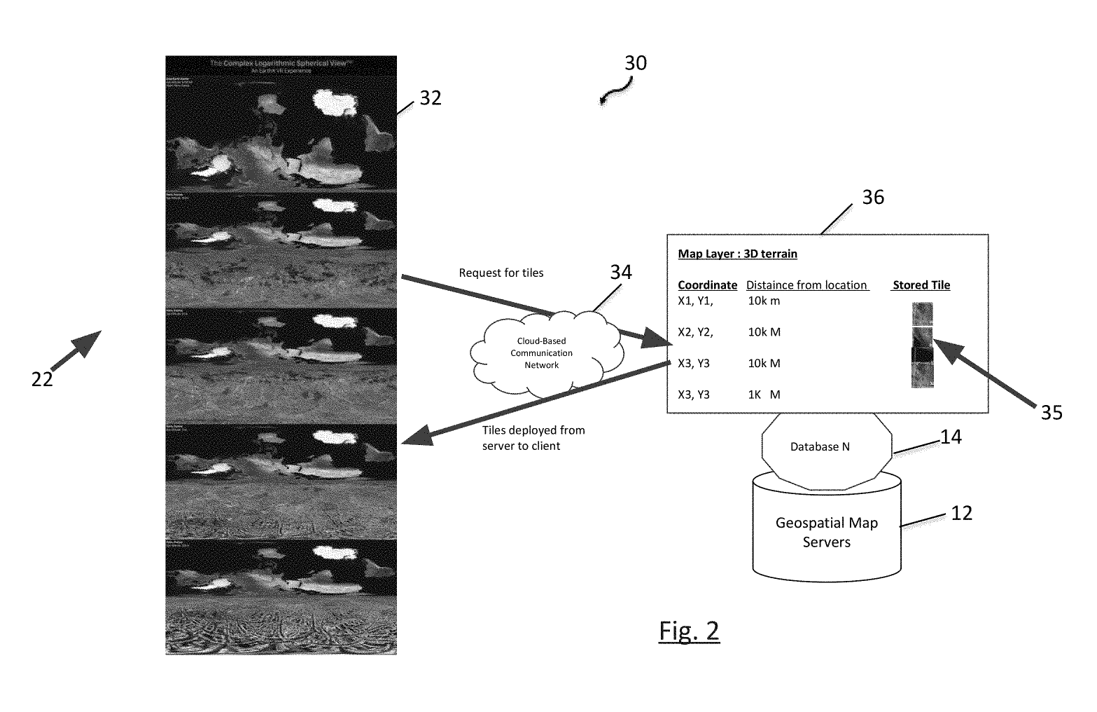

Perhaps, the greater benefit of some of the embodiments of the invention is better understood relative to FIG. 2 and its related discussion.

FIG. 2 shows an exemplary geospatial mapping system 30, in accordance with some implementations of the invention. In the geospatial mapping system 30, a client device is shown to make a request of the geospatial map server(s) 12 for map tiles, via a communication network, in accordance with an embodiment and method of the invention. Map tiles would include selected map layer and map tile information.

Shown at 22 of the display 18, is five images of the same map layer but the distance from the initial location where the client device/user was positioned is changing within the map layer. This causes re-tiling around the Location L such that tiles closer to L contain higher acuity and visual clarity than those in the far field.

The map layer/map tiling of the various implementations of the invention may be viewed via a client device display, such as but not limited to, the display of a smartphone or mobile device and can be achieved in conjunction with the use of Application Program Interface (API) capabilities that link third party data with a geospatial map servers via cloud/web communication.

In FIG. 2, a client device whose display 32 is shown in FIG. 2, transmits a request to the server 12 and database 14, through a cloud-based communication network 34, for selected map layers and map tiles. An example of the cloud-based communication network 34 is the Internet.

The map layer 36 is for 3-Dimensional (3-D) terrain and shows information map tiles 35 with each map tile being associated with not only a distinct location to also a distance from the Location L. For example, the Location “X1, Y1”, at the distance from the Location L of 10 kilometers is shown in the map tile 35. Each single location, such as X1, Y1, contains multiple associated tiles representing multiple distances from the Location L. The generated map tiles are only deployed to the client device and thereafter saved in the client device cache memory when a request is made by the client device based on either the selected areas-of-interest or the geographic position of the client device.

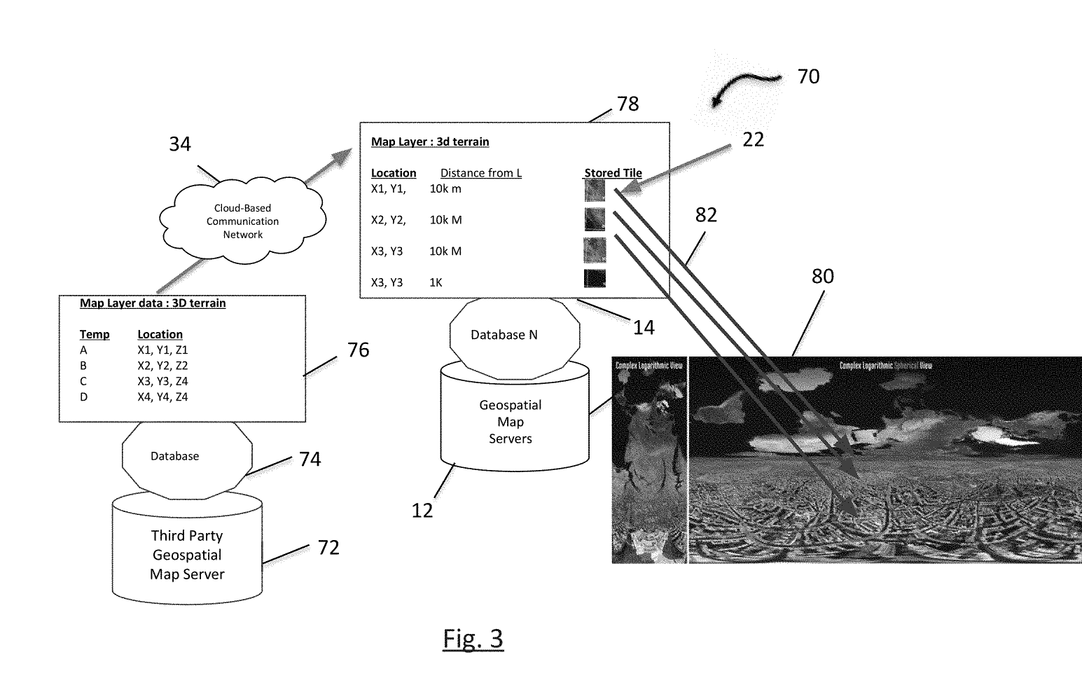

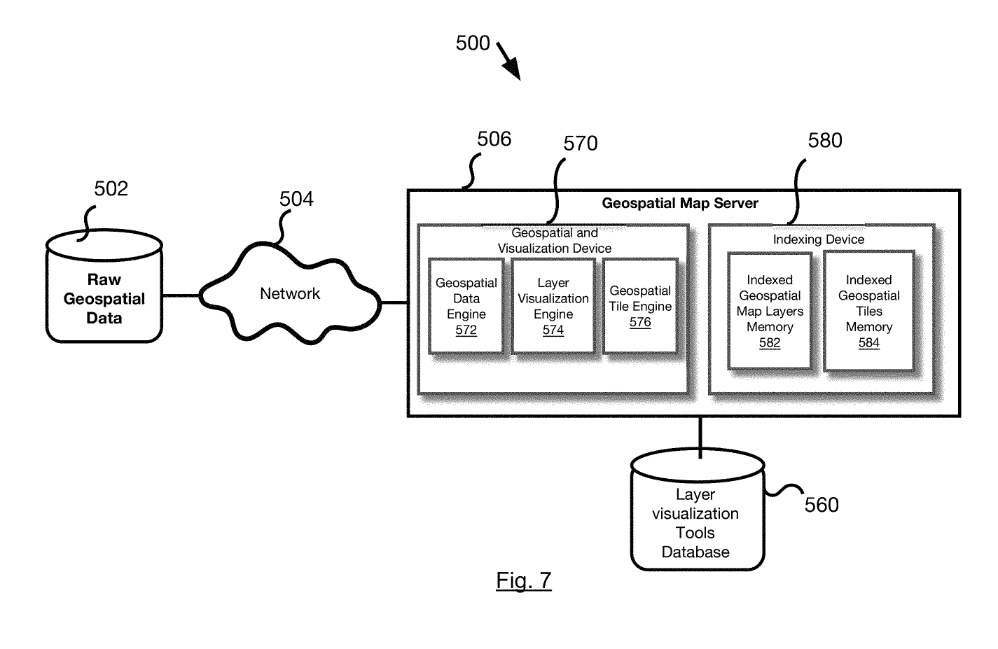

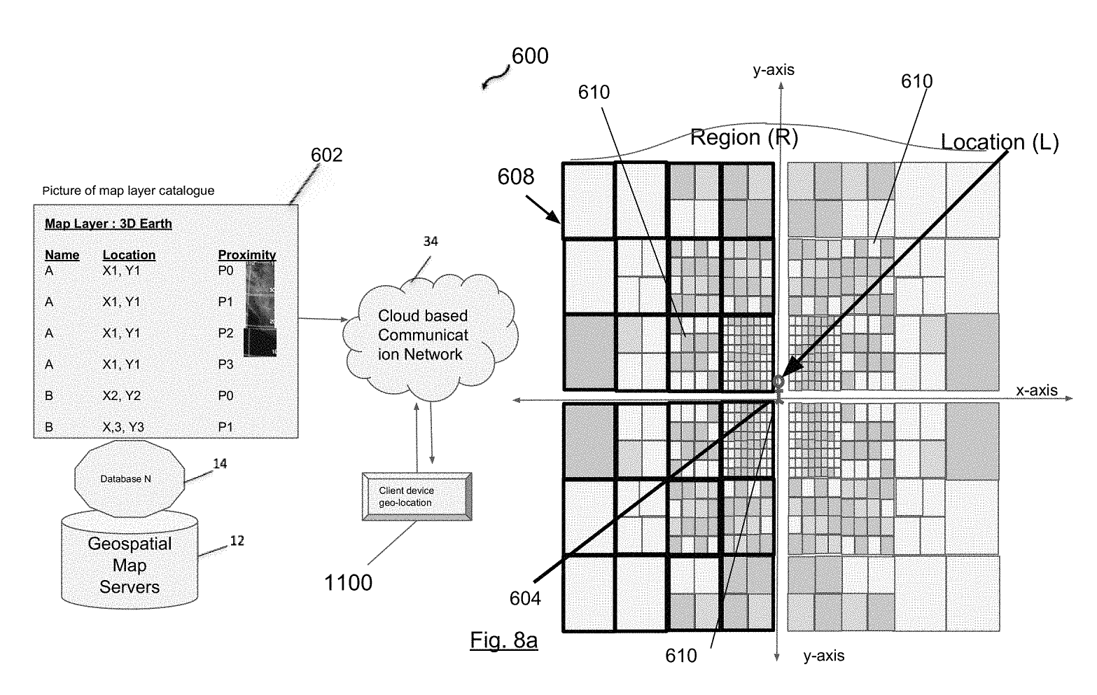

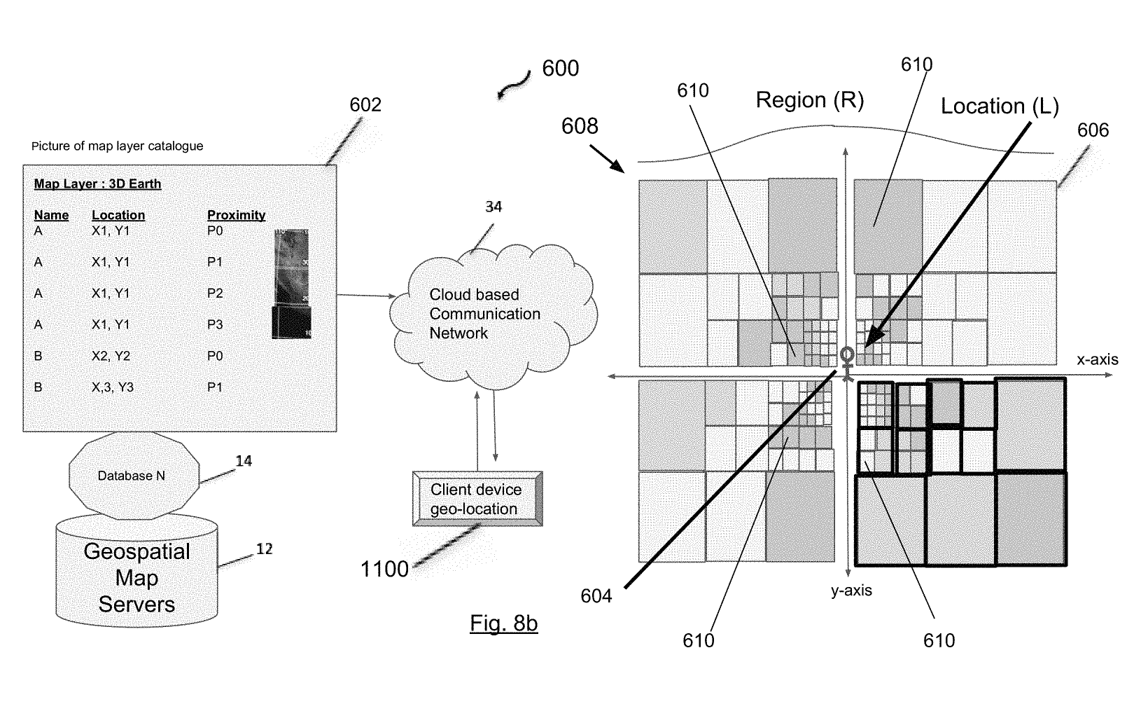

A searchable map layer database comprised of searchable map layer tiles, an example of which is shown in FIG. 3, is created in the geospatial map server 12 and database 14 pair. FIGS. 7-8 show an exemplary method of generating the searchable may layer database, as discussed below.

The area of earth shown in the display 32 of the user client device typically does not remain static and is instead often times dynamic. For example, a user of the client device may choose to zoom-in and zoom-out while viewing the selected (area of) interest or may choose to view a different area-of-interest altogether. This selection is communicated to the geospatial map server 12 and database 14 through the communication network 34, in the form of a request. In the example of FIG. 2, the request is particularly for the 3-D terrain. The geospatial map server 12 and database 14, upon receipt of this request, deploy those tiles needed for rendering the map layer, in this case, the 3-D terrain, for the region-of-interest.

Generated map layers, such as the map layer 36, referred to herein as the “selected map layer”, and associated map tiles, also generated by the combination of the server 12 and database 14, are deployed to the client device through the communication network 34. The selected map layer results in the display 38 of the user's selected area where a relevant portion of the display 32 with 3-D terrain is shown.

In the example of FIG. 2, the user is zooming in/out of the area of earth that is shown at the display 32. Accordingly, the defined geographic space in the display 38 of the client device shows the defined geographic space (selected area) changed, such as shown at the display 38. In an exemplary scenario, the user/client makes a request of the map layer database, in this case database 14, via the cloud communication network 34, and only those map tiles that are necessary to fill out the geographic space defined in the client device, displayed at 38, are transmitted through the communication network 34, to the client device.

The action of zooming in/out of the client device's display, by a user, changes the defined geographic space in the client interface. It should be noted that the client requests from the map layer database 14, via the cloud-based communication network 34, only those tiles needed to fill out the geographic space defined in the client device's interface. It should also be noted that tiling, as in FIG. 1, is non-linear.

FIG. 3 shows a geospatial mapping system 70, in accordance with some embodiments of the invention. In FIG. 3, the system 70 is shown relative to the process of deploying map tiles that are stored in the database 12. 3-D terrain map layer data 76 is assembled from the third party geospatial map server 72 and the searchable database 74. The data 76 is transmitted through the cloud-based communication network 34, to the pair server 12-database 14 where the map layer 78 is visualized. The map layer 78 is used to create tiles 22, which are generated by the server 12, and stored in the database 14. Each map layer can be used to generate multiple sets of tiles, with each set represented by congruent or non-congruent tiles of varying levels of stored information thereby creating tiles of different acuity and visual clarity. Three of the stored map tiles 22 are shown mapped to points of the globe representing the geographical location mapped by the map layer 78 of the display 80 of a user's client device (not shown in FIG. 3). The map layer 78 corresponds to the display 80 with each representing a different configuration type, at the same zoom level of viewing and at the same location.

In the example of FIG. 3, the map layer data 76 is for a 3-dimensional (3-D) terrain map layer made of data and groups of tables that are generated by the geospatial map server 72 and associated database 74. For map layer data 76, a data group named “A”, is shown to be located at “X1, Y1, Z1”, and the data group named “B” is shown to be located at “X2, Y2, Z2”. The data group named “C” is shown to be located at “X3, Y3, Z3”, and so on. The map layer data 76 is transmitted through the network 34 to the database 14 where, in combination with the server 12, map tiles are rendered, as shown at 22.

The map layer 78 is comprised of geospatial tiles and associated data (or data set). The tiles define various points of the globe in the display 80. For example, the first map layer at location “X1, Y1” and a distance from L being 10 kilometers, at time 0 (T0), translates into the tile shown at 82 and so on.

At 78, the 3-D terrain map layer, generated by the server 12-database 14 pair, includes map tiles 22, which are derived from the received map layer 76. The top-most tile points to Location: X1, Y1 with a distance of L being 10 Kilometers, at Time T=0, and the second top-most tile points to Location: X2, Y2, with the distance of L being 10 Kilometer, and so on.

A searchable map layer database comprised of searchable map layer tiles, an example of which is shown in FIG. 3, is created in the geospatial map server database pair.

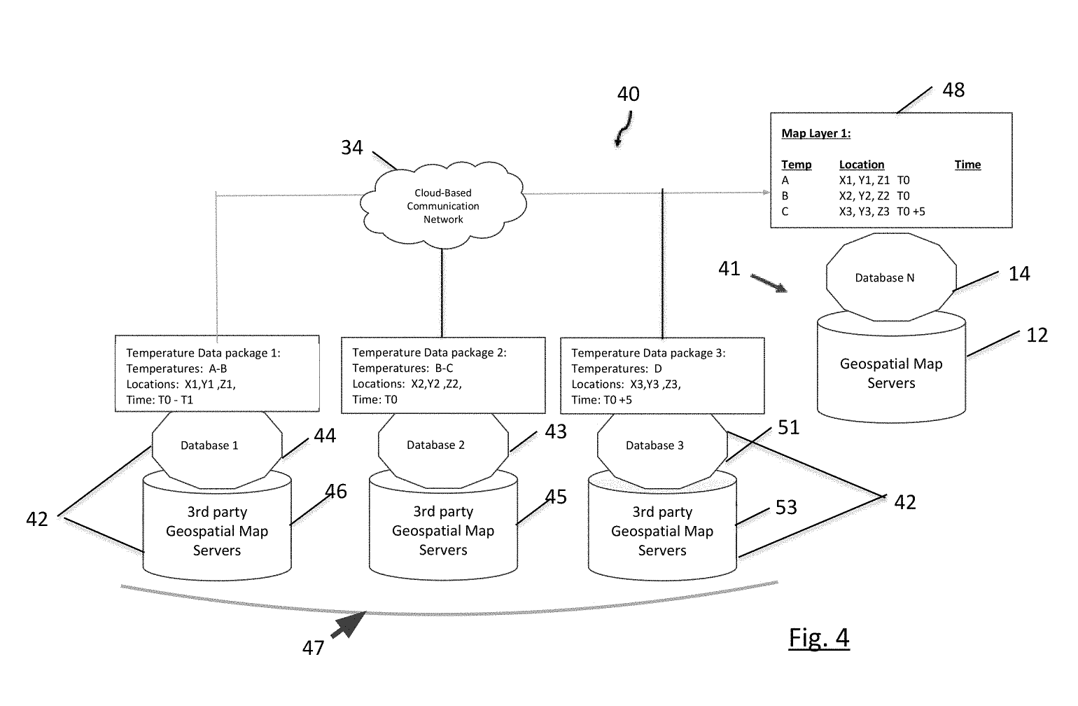

FIG. 4 shows another exemplary geospatial mapping system 40 including a number of third party servers 46 and associated database 44, in accordance with some embodiments of the invention. Relevant data that comprise a map layer is identified in multiple third party server-database pairs such as the third-party server 1 and database 1. All relevant data is transmitted vis a cloud based communication network (34) into a single database-geospatial map server pair.

While only three server-database pairs are shown in FIG. 4, it is understood that another number of pairs may be employed. The contents in each of the databases 44-46 may or may not be of a distinct format. The contents of three databases is ultimately consolidated, at 48, and saved into the single database 14.

The data points from third parties, in FIG. 4, are transmitted through the cloud-based communication network 34 to the database 14, and compiled into a single database 14 which together comprise the necessary data to create a map layer. A single map layer database is ultimately created by uploading various data and groups of data from the different databases 44 of the client device 42. The uploaded data and groups of data are subsequently compiled into a single database and sorted. This represents the data needed to compose a single map layer.

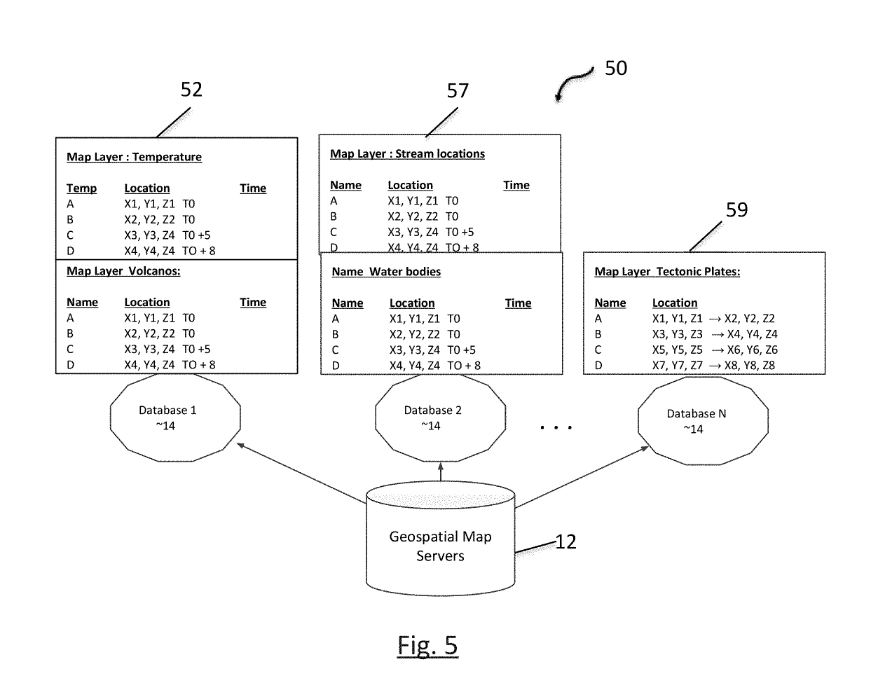

FIG. 5 shows an exemplary geospatial map system 50 with multiple map layers stored in one or more databases, in accordance with some implementations of the invention. In the example of FIG. 4, the geospatial map server 12 is shown to include N number of databases 14 with N being 3. Each of these databases stores one or more map layers. For example, one of the databases 14 stores map layers for temperature and volcano, another stores map layers for steam locations and water bodies and a third database stores one map layer for tectonic plates.

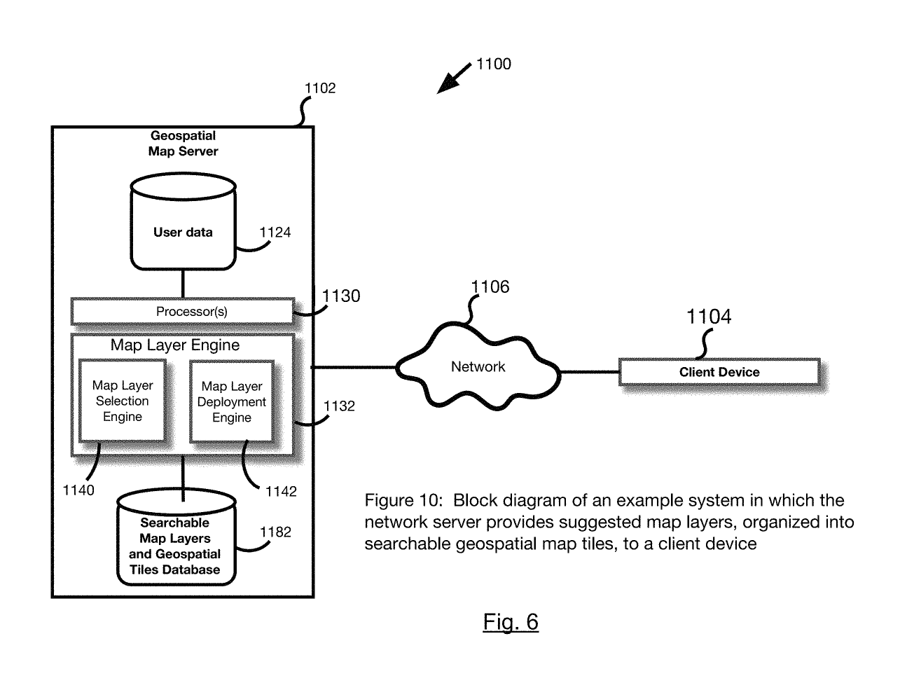

FIG. 6 shows, in conceptual block diagram form, a geospatial mapping system 1100, in accordance with some implementations of the invention. The geospatial mapping system 1100 is shown to include a geospatial map server 1102, communication network 1106, and client device 1104. The geospatial map server 1102 is shown to include a user data storage 1124, one or more processors 1130, a map layer engine 1132, and a searchable map layers and geospatial tiles database 1182, in accordance with an embodiment of the invention. The map layer engine 1132 is shown to include a map layer selection engine 1140 and a map layer deployment engine 1132 communicatively couple to one another.

The user data storage unit 1124 maintains user data as described above. The processors 1130 transmit the user data from the user data storage unit 1124 to the map layer engine 1132 and specifically to the map layer selection engine 1140. The map layer selection engine 1140 further receives the database of all map layers, which along with the user data, is provided by the client device 1104 through the communication network 1106. The map layer selection engine 1140 is also configured to detect updated user data/information from the client device 1104 through the communication network 1106. Accordingly, upon the user taking an action that affects the digital representation of the geospatial graphics, such as zooming in or zooming out, the engine 1140 is capable of detecting the same because the user information/data in the storage unit 1124 changes.

The database 1182 maintains a searchable version of map layers and geospatial tiles. The selection engine 1140 performs a search of the database 1182 for the relevant map layers. Upon detecting a match, the selection engine 1140 realizes recommended/suggested map layers from the database 1182 and is able to provide the same and associated geospatial tiles to the deployment engine 1142. Accordingly, the selection engine 1140 generates suggested/recommended map layers, organized into searchable (geospatial) map tiles. These searchable map tiles are transmitted to the deployment engine 1132.

The deployment engine 1132 deploys the searchable (geospatial) map tiles to the client device 1104 through the network 1106. The deployment engine 1132 also communicates with the client device 1104, via a communication network 1106, and responds to updates (geolocation changes) made by the client device, to ensure that pre-selected map layers are continuously deployed around the client device's' geographic position, Location L (or the area-of-interest identified by the client device interface).

The processors 1130 are used by the selection engine 1140 and deployment engine 1132 for calculation or processing of the above-discussed steps. The network 1106 is analogous to the network 34 of prior figures, the server 1102 is analogous to the server 12 of FIG. 1, the database 1182 is analogous to the databases 52 of FIG. 4, and the client device 1104 is analogous to the client devices shown in FIG. 3.

FIG. 7 shows, in conceptual block diagram form, a geospatial mapping system 500 with further details of the server 506, in accordance with some embodiment of the invention. The geospatial mapping system of FIG. 6 is analogous to the server 1102 of FIG. 5. The server 506 receives raw geospatial data 502 from the client device, as previously discussed relative to prior figures. The server 506 is shown to include a geospatial and visualization device 570 and an indexing device 580. The layer visualization tools database 560 is in communication with the network server 506.

The geospatial and visualization device 570 is shown to include geospatial data engine 572, layer visualization engine 574, and geospatial tile engine 576. The indexing device 580 is shown to include indexed geospatial map layers memory 582 and indexed geospatial tiles memory 584. It goes without saying that the indexed geospatial map layers memory 582 maintains indexed geospatial map layers and the indexed geospatial tiles memory 584 maintains the indexed geospatial tiles.

The system 500 generally processes the raw geospatial data 502 into indexed visualized map layers that are further subdivided into indexed searchable tiles. As previously explained, the raw geospatial data 502 is received through the network 504. The geospatial data engine 572 processes and organizes the raw geospatial data 502 into searchable geospatial data. For example, as noted with reference to prior figures, the raw geospatial data is organized into groups of data according to their corresponding map layers. For instance, the data relating to the map layer for temperature are grouped together.

Processing and organizing of the raw geospatial data 502 is shown and described relative to FIGS. 7-8 of U.S. patent application Ser. No. 15/465,474, filed on Mar. 21, 2017, by Kyle Vanderlugt, et al., and entitled “SYSTEM AND METHOD FOR RENDERING GEOSPATIAL MAPS”, which is incorporated herein by reference as though set forth in full. In summary, multiple datasets are downloaded and consolidated into a single database, and then manually sorted, copied, pasted, revised, . . . , into another database, etc . . . FIGS. 7 and 8 show an exemplary method of progressively grouping and sorting datasets.

Once processed and organized, the geospatial data, in FIG. 6, is provided to the layer visualization engine 574 to be stylized for artistic effect using the tools available in the layer visualization tools database 560. Application of the tools of database 560 to the data, by the layer visualization engine 574, generates a map layer. Lastly, the generated map layer is processed into indexed individual geospatial tiles (“indexed map tiles”, “indexed geospatial tiles”, or “geospatial (map) tiles”) using the geospatial tile processor 576. The indexed visualized map layers 582 and their associated tiles 584 are stored in the indexed geospatial map layer memory 582 and the indexed geospatial tiles memory 584, respectively, of the index device 580 within the network server 506. The indexed geospatial map layers in the memory 582 and the indexed geospatial tiles in the memory 584 are ultimately deployed to the client device.

FIGS. 8a and 8b show, in conceptual block diagram form, a geospatial mapping system 600, in accordance with various implementations of the invention. FIG. 8a shows congruent tiles being assembled around L. All tiles have the same size and shape but each tile contains a different level of information/data (and thus acuity). In FIG. 8a, system 600 is shown to include the server 12, database N 14, cloud-based communication network 34, and client device 1100. The database N 14 includes the map layer of a 3-D earth comprised of tiles with associated information such as Location (L), and Proximity. Proximity is the distance from the geographic location of a tile to either the Location (L) (of the client device), as determined by a GPS, or to the point-of-interest, identified by user through the client device interface.

The system 600 is a system for rendering geospatial maps using differential map tiling process when navigating 3-D map layers. FIG. 8a also shows a graph 608, with x and y-axes, that conceptually represents the acuity effect of the non-linear nature of the map tiles, a few of which are shown in various quadrants of the graph 608, at 610. In the implementation of FIG. 8a, the map tiles are assembled inverse linearly relative to when the client device, or user 604 thereof, stands at location (L) within the Region (R). Accordingly, as shown in FIG. 8a, the size of the tile maps 610 are congruent but the amount of information stored or shown in each tile varies. The closer the map tiles to the user 604, the more information is shown in each tile. As distance increases between the position of the tile and the location of the user, the stored pixel information decreases. The effect is that as the tiles are assembled into a map layer around the Location L, the visual acuity progressively decreases as distance away from the user increases. It is understood that while linear, logarithmic or other types of non-linear functions relative to map tiles is discussed herein, any other suitable type of non-linear function may be employed.

In various implementations of the invention, map tiling is performed non-linearly in the client device display, such as the display 78 or 36, an area-of-interest and the map tiles are compressed using a known compression technique. In light of the logarithmic, or non-linear, nature of the map tiles. The map tiles do not contain the same level of compressed information and thus visual acuity.

The map tiles may be generated and assembled such that the tiles closer to the location (L) of the client device are displayed with greater acuity, and perhaps even larger, relative to those located farther away from the client device. This results in decreased processing time and a lower memory/storage capacity requirement. Accordingly, the tiles may or may not be the same size. Only the level of data or detail in the tiles change, thus changing their acuity. The assembled tiles can form the 3-D map layers which can be set in a number of geometries, in accordance with various implementations of the invention. As previously noted, non-linear may include spherical and logarithmic. These geometries are agnostic to actually generating the tiles and relate to how the configuration file reads the tiles and assembles them into the right shape that is shown on the device.

FIG. 8b shows non-congruent tiles—tiles that do not have the same size. The information/data in or associated with each tile may or may not have the same level of detail as the information/data of other tiles. The implementations of FIGS. 8a and 8b represent two different ways to assemble tiles to create non-linear map tiling. Accordingly, in some implementations of the invention, non-congruent tiles with different shapes and/or sizes may be employed. For instance, the tiles of a group of map tiles may be distinct or the tiles across groups of map tiles may be distinct.

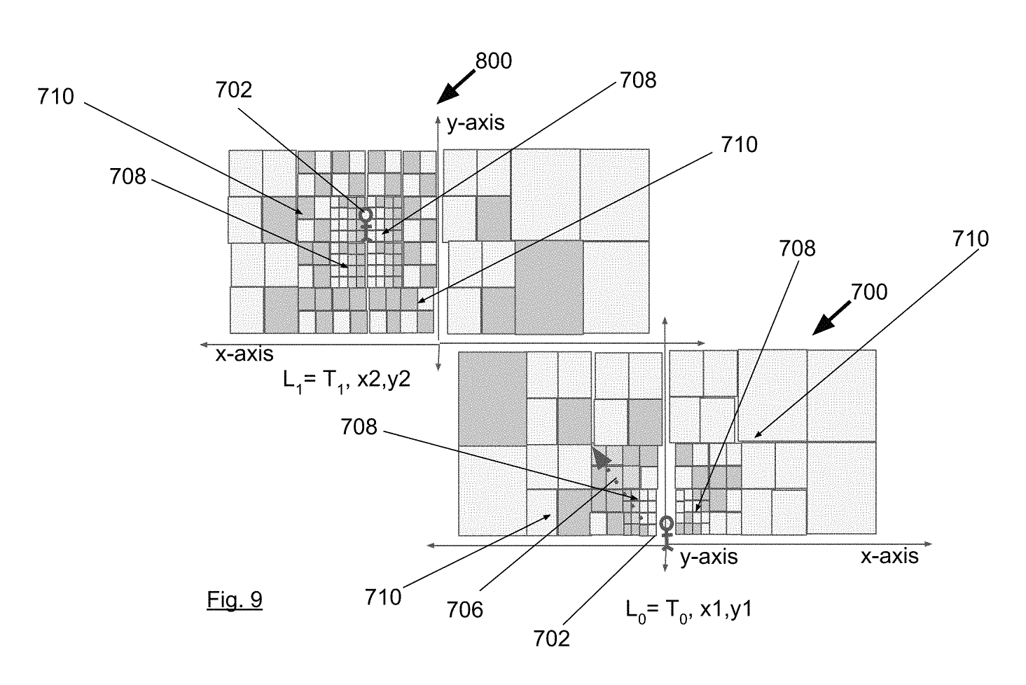

FIG. 9 shows exemplary implementations of maps showing 3-D navigation using differential map tiling process of the various implementations of the invention. Maps 700 and 800 are the same map with different parts of the map shown in each map. In map 700, the user 702, shown as a stick figure, navigates starting from the location it is currently shown, denoted by “L0” and travels to location “L1”, shown in the map 800. The user 702 is shown to walk in a direction shown by the dashed arrow 706, to get to L1. In the equation “L₀=T₀, x1,y1”, “L0” represents location zero, where the user 702 is initially located. “T0” represents time 0 or the time right before the user 702 starts to move. The coordinates “x1, y1” represent the X-Y coordinates defining the location L0 of the user 702. Thus, the initial location of the user 702 is the X-Y coordinates at the time T0. Similarly, in the equation “L₁=T₁, x2, y2”, L1 represents the location of the user 702 after the user has moved. T1 represents the time when the user 702 is at location L1 and “x2, y2” represent the X-Y coordinates of the location L1.

Moving along a X-Y coordinate plan as determined through for example, a global positioning system (GPS) geolocation, changes the defined geo-boundaries in a client device interface of the client device of the user 702. A change in the location of the user 702 automatically results in requests for new tiles, by the client device, to the geospatial map server. Automatic change in the location of the user is detected due to a change in the Location (L) and Region (R) of the user 702.

It is contemplated that various implementations of the invention may be in the form of web-based applications and/or native applications.

Tiles in the near field, the areas 708 shown in FIG. 9, close to the user 702, are shown, on the user's client device display, with higher resolution than those in the far field, which are shown by the areas 710, in FIG. 9.

The constant re-tiling of FIG. 9 due to the user's movement, can result in several tiles characterizing a single location where the user 702 is located and these several tiles vary in their acuity consistent with to the distance to the user 702 travels. In FIG. 9, the location of the user 702 changes from L₀ to L₁ corresponding to moving over time from t₀ to t₁ result in the tiles being re-deployed around the user's new location. Tiles around x1, y1 at L₀ have higher acuity than X2, Y2. But at L₁ those tiles around x2, y2 have higher acuity than x1, y1.

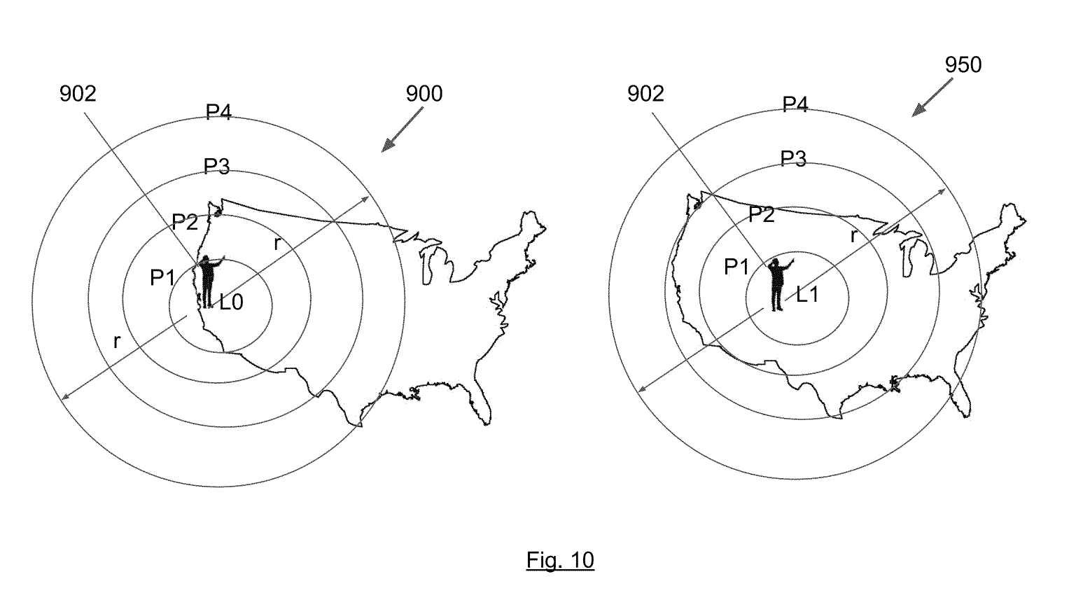

FIG. 10 shows a map of a user navigating from one location, shown in one map, to a new location, shown by the other map. More specifically, the user 902 starts at the location, L0, shown in the map 900 and map 950 shows the same area as that of map 900 but with the user 902 at a new/different location, L1. In FIG. 10, “r” represents the radius of the area around the user 902 for which map tiling is performed. “P1”, “P2”, “P3”, and “P4” represent various proximities to the user 902.

The map 900 of the location L0 will have area in P1 tiled at higher fidelity and acuity (closer to L0) than areas progressively further away from the location L0 (within the Region R). The map 950 of the location L1 has an area in P1 tiled at higher fidelity and acuity (closer to L0) than areas progressively farther away from the location L0 (within region R). It should be noted that the maps of FIGS. 8 and 9 are tiled using non-linear techniques.

FIG. 11 shows various configurations that may be employed in some implementations of the invention to assemble map layers of various geometries relating to how a user would visualize map layers. These configurations also differ in the relative location and position of a user to the earth. At 1000a, the user is shown inside the globe where map tiles are generated for the area of the globe that surrounds the user. At 1000b, the user is shown standing under and inside the globe therefore, map tiling is going to be performed of the area shown above and outwardly relative to the user. At 1000c, the user is shown within the top half of the dome/globe, accordingly, map tiles are generated for this area. At 1000d-1000g similarly show the user located at various other places with the generation of map tiles shown accordingly. At each of the locations of the user, 1000a-1000h, the area that is tiled is shown by a tiled area at 1002.

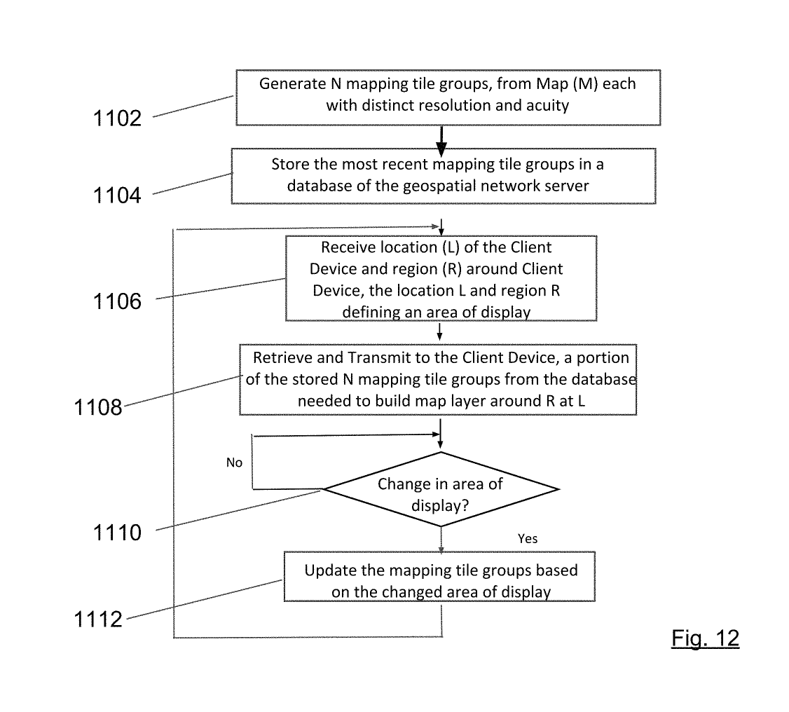

FIG. 12 shows a flow diagram of steps performed to generate map tiles, in accordance with exemplary implementations of the invention. At 1102, “N” number of map tiles are generated, “N” being a real or integer value by the geospatial map server, such as the server 12 in FIG. 1. N number of map tiles are generated from an M number of maps with distinct resolution and acuity, “M” being a real or integer value. The generated map tiles may each be convex, concave, or other suitable shapes. The map tiles may each have a number of different shapes and/or configurations so as to generate multiple map geometries.

Next, at 1104, the most recent group of map tiles (associated with a particular map layer), received from the client device, are stored in the database 14 of FIG. 1, for instance. Next, at 1106, the geospatial map server 14 receives Location (L) and Region (R) information from the client device, “L” being the location of the client device, which may be in coordinate or other formats, and “R” being a relevant, or area-of-interest to the user, region. The latter may be based on the size of the display area of the client device where the map is to be displayed. Accordingly, “L” and “R” define the absolute display area of the client device using the GPS coordinates of the location of the user's client device.

The client device sends request to the geospatial map server for the map tiles needed to build map layer at device location (L) for region R. These tiles represent just a portion of all available tiles for the map layer.

After step 1106, the server 12 transmits to the client device, some of the stored N number of map tiles from the database 14. The portion of the stored N number of map tiles selected for transmission to the client device is at least in part, based on the map layer that needs to be built around R, at L. That is, the area on the screen dictates the area for which a request is made by the client device to the geospatial map server for tiles.

The identification of tiles that are to be visible to the user (deployed by the geospatial map server) is based on the specific map layer and how much information is being displayed, the actual tile assembly process, and the like. The request, made by the client device, results in the foregoing types of tile assembly performed by the geospatial map server. Therefore, the geospatial map server only deploys a select number of tiles so that the cache memory of the client device need only to store these selected tiles as opposed to storing all of the tiles. Therefore, in some embodiments of the invention, the select number of tiles are only those tiles that make up the map in the Region R. These selected tiles are continuously taken out of the cache memory of the client device to make room for new ones. In an implementation of the invention, the selected tiles are not discarded from the server database, i.e. database 14. They are, rather, maintained in perpetuity in the server database. When the tiles are sent by the server 12 to the client device, they are not actually removed from the server 12 before being sent, instead, a readable copy of these tiles are sent to the client device.

Each request may be, and general is, different for each map layer, for example, at each zoom and at each region of the screen/display. There are practically an infinite number of combinations of tile requests and map assembly protocols.

Thus, at step 1108, essentially two steps are performed by the server 12. One step is to retrieve the map tiles from geospatial server storage that are to be transmitted to the client device and another step is to transmit the retrieved map tiles to the client device, through the communication network, as previously discussed. Map layers will be used to create a number of map tiling groups, a group of map tiles corresponding to a particular map layer, each of the map tiles have a distinct acuity and spatial resolution (as shown in FIG. 2).

The client device assembles the map tiles to generate a map layer for region R and around location L using a non-linear method (as shown in FIG. 3).

A change in the area of display or a change in the location of the client device triggers a request for the new tiles needed to generate R, at Location L. The new tiles are then assembled. Therefore, after step 1108 and at 1110, a decision is made by, for example one or more of the processors of the server 12 for the potential detection of changes to the client device's display area, i.e. L and R. For example, upon the user moving the curser to a different area or zooming into a particular area, while the location, L, initially transmitted by the client device may not change because the client device has remained substantially in the same location, R might have changed. L and R information is continuously transmitted by the client device or transmitted at a time when a change in R and/or L is detected by the client device, with the latter resulting in power savings over the former, and perhaps even performance enhancement.

Upon the detection of a change in the display area of the client device, the process continues onto step 1112 where the map tiles are updated based on the changed display area and subsequently, the process repeats starting from step 1106. Upon the detection of no change to the display area at 1110, the process continues to and starts executing from, step 1106.

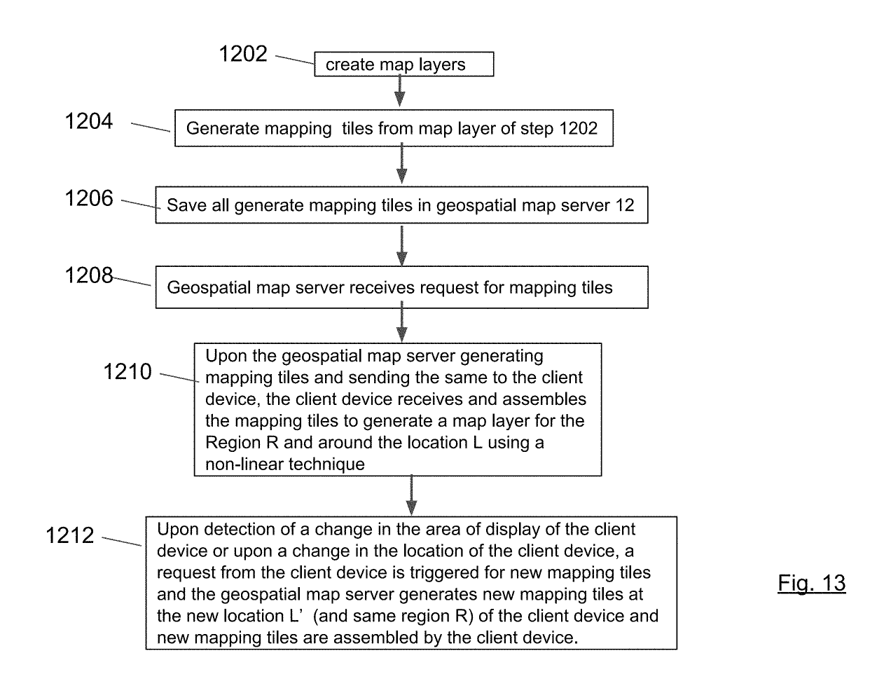

FIG. 13 shows a flow diagram of the interaction between the client device and the geospatial map server, in accordance with various implementations of the invention. At step 1202, map layers are created by the client device. Next, at step 1204, map tiles are generated by the geospatial map server from the map layers created by the client device. Next, at 1206, the generated map tiles are saved in the database or other memory of the geospatial map server and thereafter, at step 1208, the geospatial map server receives a request for map tiles, the request includes or is followed by other information, such as L and R. It is understood that step 1208 can occur at a different time or after or before a different step than that which is shown in FIG. 12.

After step 1208, at step 1210, once the geospatial map server has completed generating map tiles and sends the map tiles to the client device, the client device assembles the map tiles it receives into a map layer for display to the user. The map layer is for the Region R and around the Location L.

At step 1212, upon the detection of the area of display of the client device, such as the location of the client device, the client device sends another request, along with R and new location L (L′) to the geospatial map server for updated/new map tiles. The geospatial map server then generates new map tiles based on R, L′ and sends the generated map tiles to the client device, which ultimately assembles the generated map tiles to create one or more map layers. In some implementations of the invention, deployment of multiple map layers is not concurrent while optionally, in some embodiments, a user can switch the view of a map layer, on the client device display, from non-linear (algorithmic, spherical etc . . . ) to linear.

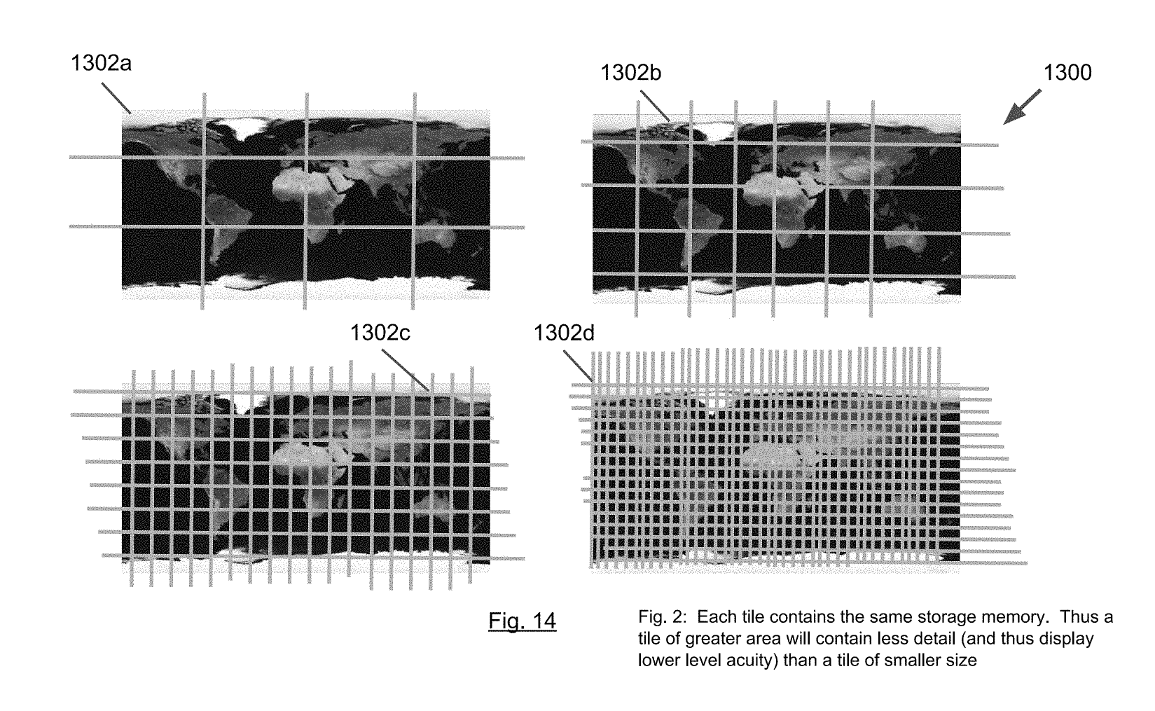

FIG. 14 shows various map tiles 1300, in accordance with some of the implementations of the invention. Map tiles 1302a clearly has fewer tiles than the remaining map tiles 1302b, 1302c, and 1302d with the number of map tiles being progressively larger. For example, map tiles 1302d have the most number of tiles. In an exemplary implementation, a map tiles 1302a through 1302d has the same amount of storage memory associated therewith into which the map tile information is saved. Thus, a tile of greater area, such as the tiles 1302a, will have less detail (and thus display lower level acuity) than a tile of smaller size, such as the tiles 1302d.

FIGS. 15-16 show screen shots of an exemplary implementation of the invention where a map catalogue including various map layers is presented to the user at the client device interface/display and the resulting effect of the user's selection of one of the map layers. More specifically, in FIG. 15, an image of Earth is presented to the user along with a map catalogue including a number of map layer options, i.e. Earth At Night, Earthquakes, Flood Occurrence, and Forest Change. Upon the selection of one of the map layers of the map layer catalogue by the user clicking a corresponding button, the client device requests new map tiles for a selected map layer to be generated and assembled and provides a new R or new L or new R and L to the geospatial map server for this purpose. For a better understanding of the foregoing process, the reader is directed to U.S. patent application Ser. No. 15/465,474, filed on Mar. 21, 2017, by Kyle Vanderlugt, et al., and titled “SYSTEM AND METHOD FOR RENDERING GEOSPATIAL MAPS”. Upon the assembly of new map tiles, they are deployed to the client device. In this example, because the user has selected the map layer “Earthquakes”, the resulting map layer, shown in FIG. 16, is of the locations where earthquakes have been spotted around the globe.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Although the description has been described with respect to particular not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What we claim is:

1. A method of geospatial mapping of a map layer comprising:
generating N number of map tiles, ‘N’ being an integer value, each of the map tiles associated with a unique resolution and acuity, a group of map tiles defining a non-linear map layer and a group of map layers defining a map layer catalogue;
storing the generated N map tiles in a server database before deployment thereof to a client device;
receiving, from the client device, location (L) and region (R) information, defining a current location of the client device, the combination of the location L and the region R defining an area of display presented to a user by the client device; and
upon activation by the user, deploying a portion of the stored map tiles, of one or more groups, to the client device to be assembled and displayed as a map layer in an area of the client device defined by L and R.

2. The method of geospatial mapping of claim 1, wherein each of the non-linear map layers is made of map tiles associated with the unique resolution and acuity based on a spatial resolution of information.

3. The method of geospatial mapping of claim 1, wherein the number of map tiles is based on the spatial resolution of information, wherein the higher the resolution of the information associated with the map tiles, the greater the number of map tiles that can be created and the higher the resolution of a non-linear map layer made of the greater number of map tiles.

4. The method of geospatial mapping of claim 1, wherein an acuity of an area at a client device location or the area of display by the client device increases as a result of either assembling map tiles with higher levels of stored information or by increasing a number of map tiles around the area of display or device location (L).

5. The method of geospatial mapping of claim 1, wherein a change in either the L or the R causes the change in the area of display.

6. The method of geospatial mapping of claim 1, further including polling the L and the R to detect a change.

7. The method of geospatial mapping of claim 1, wherein near field map tiles defined by as those map tiles that are close to L within R include a greater number of map tiles relative to far field map tiles defined as those map tiles that are further from L within R.

8. The method of geospatial mapping of claim 1, wherein near field map tiles defined by as those map tiles that are close to L within R include a greater number of stored data per map tile than far field map tiles defined as those map tiles that are further from L within R and the near field map tiles have higher acuity than far field map tiles.

9. The method of geospatial mapping of claim 1, further including assembling at least some of the map tiles in decreasing order of acuity or stored data that create a non-linear map layer.

10. The method of geospatial mapping of claim 1, wherein only map tiles of the portion of the stored map tiles are deployed by the geospatial map server.

11. The method of geospatial mapping of claim 1, wherein the map tiles of the portion of the stored map tiles define the area of display of the client device and visible to the user.

12. The method of geospatial mapping of claim 1, wherein the activation includes selection of a non-linear map layer from a map layer catalogue presented in the area of display to the user by the client device.

13. A nontransitory computer readable medium having stored thereon software instructions that, when executed by one or more processors, cause the one or more processors to perform operations including:
generating N number of map tiles, ‘N’ being an integer value, each of the map tiles associated with a unique resolution and acuity, a group of map tiles defining a map layer and a group of map layers defining a map catalogue;
storing the generated N map tiles in a server database;
receiving, from a client device, location (L) and region (R) information, at a current location of the client device, the combination of the location L and the region R defining an area of display displayed by the client device; and
upon activation by a user, deploying a portion of the stored map tiles to the client device to be displayed to a user by a client device display of the client device, the portion being based on a size of the area of display of the client device.

14. The non-transitory computer readable medium of claim 13, wherein each of the map layers is made of map tiles associated with the unique resolution and acuity based on a spatial resolution of information.

15. The non-transitory computer readable medium of claim 13, wherein a size of the map tiles remains constant despite an increase in the acuity of the map tiles.

16. The non-transitory computer readable medium of claim 13, wherein the number of map tiles is based on an individual map layer and the higher the resolution of the information associated with the map tiles, the greater the number of map tiles that can be created and the higher the resolution of the individual map layer.

17. The non-transitory computer readable medium of claim 13, wherein an acuity of an area of display at a client device location increases as a result of either assembling map tiles with higher levels of stored information or by increasing a number of map tiles around the area of display or device location (L).

18. The non-transitory computer readable medium of claim 13, wherein a change in either the L or the R causes the change in the area of display.

19. The non-transitory computer readable medium of claim 13, wherein the activation includes selection of a map layer from a map layer catalogue presented to the use at the area of display and upon the selection, a change in either the L or the R or both occurs in the area of display causing assembling of new map tiles associated with the selected map layer.

20. A geospatial mapping system comprising:
a geospatial map server having a database and a deployment engine and operable to generate N number of map tiles, ‘N’ being an integer value, a group of the map tiles defining a map layer, each of the map tiles having associated therewith a unique resolution and acuity, the geospatial map server further operable to store the generated N map tiles in the database, upon receipt of location (L) and region (R) information at a current location of a client device from the client device, the deployment engine being operable to deploy a portion of the stored map tile groups to the client device to be displayed at an area of display of a client device display of the client device, the portion being based on a size of the area of display, the combination of the location L and the region R defining the area of display,
wherein upon activation by the user, the geospatial map server assembles an updated N number of map tiles associated with a map layer selected upon the activation.

21. The geospatial mapping system of claim 20, wherein each of the map layers is made of map tiles associated with the unique resolution and acuity based on a spatial resolution of information.

22. The geospatial mapping system of claim 20, wherein the number of map tiles is based on an individual map layer and the higher the resolution of the information associated with the map tiles, the greater the number of map tiles that can be created and the higher the resolution of the individual map layer.
